(19) United States
(12) Patent Application Publication
(10) Pub. No.: US 2018/0292150 A1
(43) Pub. Date: Oct. 11, 2018

(54) SYSTEM FOR CLEANING AN OBJECT SUCH AS A HEAT EXCHANGER

(71) Applicant: PEINEMANN EQUIPMENT B.V., HOOGVLIET (NL)

(72) Inventor: Michael Kenneth BRUMFIELD, Bridge City, TX (US)

(21) Appl. No.: 15/767,620

(22) PCT Filed: Oct. 14, 2016
(86) PCT No.: PCT/EP2016/074753

§ 371 Date: Apr. 11, 2018

Related U.S. Application Data
(60) Provisional application No. 62/242,506, filed on Oct. 16, 2015.

(51) Int. Cl. F28G 15/02; B08B 9/032; F28G 1/16; F28G 15/04

(52) U.S. Cl. CPC F28G 15/02; F28G 15/04; F28G 1/163; B08B 9/0325

(57) ABSTRACT

System for cleaning an object, such as a heat exchanger comprising a bundle of feed-through tubes extending between two end plates, wherein the system comprises a connection body for connecting the system to an object, a holder for holding a cleaning device and a moving system for moving the holder with respect to the connection body in a first direction and a second direction at least having a component perpendicular to the first direction, wherein the moving system comprises a rotation motor and a linear motor.

The present invention relates to a system for cleaning an object, such as a heat exchanger comprising a bundle of feed-through tubes.

For instance in the petrochemical industry, frequent use is made of heat exchangers for the purpose of cooling or heating fluid flows. A common heat exchanger is a tube heat exchanger consisting substantially of a bundle of tubes extending between two end plates or a common end plate enclosed by a casing. In the course of time these tubes become fouled such that the through-flow is blocked or restricted. In order to enable the heat exchanger to function optimally again the tubes are cleaned by injecting liquid under high pressure through these tubes using a high-pressure lance.

These lances are typically in the form of high-pressure hoses which carry a high-pressure injection nozzle on their front end. These hoses are pushed or fed into the heat exchanger pipes. After the high-pressure source for the washing liquid has been set into operation, the dirt is removed from the tube and the hose can herein be pushed further into the tube, until the whole length of the tube is cleaned.

As the lances carry liquid under very high pressure, a cleaning device is typically used to introduce and push the lances into the tubes, such that manual operation of the lances is not required. A suitable cleaning device as such is described in international patent publication WO 01/11303A1. This cleaning device arranged for driving a flexible lance is provided with a frame in which a means driving a flexible lance is arranged for moving this flexible lance in the direction of an outlet opening. This cleaning device is operated by manually aligning the outlet opening with an opening of a tube and by subsequently operating the driving means for introducing the lance in said tube.

In order to further reduce the chances of accidents involving the high pressure liquid, it is known to couple the above mentioned cleaning device to a moving system for moving the cleaning device with respect to heat exchanger, such that manually operating the cleaning device is not longer needed. Such a moving system may for instance comprise a framework having a first set of beams onto which a perpendicularly oriented second beam can travel, for instance using a linear motor. The cleaning device can then travel, for instance also using a linear motor, on the second beam such that cleaning device is movable in a first direction and a second direction at least having a component perpendicular to the first direction. The motors for moving the cleaning device are remotely operable, such that the operator can operate the cleaning device from a safe distance.

Although this known moving system improves the safety by allowing remotely operating the device, this known moving system having a relatively large frame is less useful in situations with limited space, for instance when the heat exchanger is to be cleaned in situ, instead of in a dedicated cleaning location. Moreover, moving the known moving system between locations, in particular between objects to be cleaned, is labor intensive, in particular due to the size of the system.

It is a therefore a goal of the present invention, next to other goals, to provide an improved system for cleaning an object, in particular a heat exchanger, wherein at least one of the above mentioned problems is at least partially alleviated.

This goal, amongst other goals, is met by a system according to appended claim 1. More specifically, this goal, amongst other goals, is met by a system for cleaning an object, such as a heat exchanger comprising a bundle of feed-through tubes extending between two end plates, wherein the system comprises a connection body for connecting the system to an object, a holder for holding a cleaning device and a moving system for moving the holder with respect to the connection body in a first direction and a second direction at least having a component perpendicular to the first direction, wherein the moving system comprises a rotation motor and a linear motor. By using a rotation motor in combination with a linear motor for moving the holder, and therewith the cleaning device, a relatively compact moving system is obtained. This makes the system according to the invention in particular useful for cleaning heat exchangers in situ.

It is preferred if the system is provided with one linear motor and one rotation motor only to actively move the holder and therewith the cleaning device. In other words, the holder in the moving system is actively moved in the first and second directions with respect to the object to be cleaned by only one rotation motor and one linear motor.

The connection body, or connecting means, is preferably arranged to stably hold and support the driving system by coupling the system to a stable environment. Although it is possible that the moving system according to the invention can be coupled to any suitable member associated with or located near the object to be cleaned, it is preferred if the connection body is arranged to be coupled to the object to be cleaned itself. Any further support members, for instance in the form of frames and the like, are then not required for operating the system.

According to a further preferred embodiment, the connection body is arranged to be coupled to the flange of a heat exchanger. This efficiently aligns the system with the heat exchanger to be cleaned. The connection body may be coupled to the flange, or any other part of the heat exchanger, for instance using a clamp for clamping around the flange, but it is preferred if the connection body is provided with a coupling plate with at least two openings for receiving bolts for coupling to the heat exchanger flange. The openings in the flange which are in use of the heat exchanger used for connecting an end plate, can thus be used for connecting the system according to the invention to the heat exchanger. In order to be able to connect to different types and sizes of heat exchangers, having different configurations of the openings in the flanges, it is preferred if the coupling plate is provided with a plurality of openings and/or wherein at least one of the openings is slot shaped.

The holder is arranged to hold a cleaning device, preferably a cleaning device arranged for driving a flexible lance for cleaning a heat exchanger duct or the like, provided with a frame in which a means driving a flexible lance is arranged for moving this flexible lance in the direction of an outlet opening. Such a device is described in WO 01/11303A1, which is hereby incorporated by reference. The holder is thereto preferably provided with a receptacle shaped to receive the above mentioned frame or any outer housing, wherein the holder is further provided with a coupling, or coupling means, for coupling the cleaning device to the holder. The coupling may for instance comprise a clamp or any suitable connection for preferably removably coupling the cleaning device to the holder. A further preferred embodiment according to the invention further comprises a cleaning device, preferably a cleaning device of the above mentioned type, coupled to the holder.

It is noted that also other cleaning devices than the type mentioned above may be coupled to the holder. It is for instance possible to couple a cleaning device having a nozzle for cleaning the end plate, i.e. the structure between the ends of the tubes, of a heat exchanger. It may further be possible that the holder is arranged to couple and hold only a guiding tube for a lance, wherein said guiding tube extends between an externally located cleaning device provided with the driving means as mentioned above and the holder of the system according to the invention.

A further preferred embodiment of the system according to the invention further comprises a supporting arm for supporting the holder. The supporting arm hereby preferably has a suitable length such that the holder can be aligned with any of the tubes in a heat exchanger. Preferably, the rotation motor is arranged to rotate the supporting arm with respect to the connection device. The supporting arm and the holder are then movable with respect to the connection body, and thereby with respect to the object to the cleaned. It is preferred in terms of compactness if the system according to the invention is provided with one supporting arm only.

According to further preferred embodiment, the linear motor is arranged to move the holder in a plane perpendicular to the rotation axis of the rotation motor. The combination of the linear motor and the rotation motor thereby allows moving the holder in said plane, thereby efficiently moving the holder in the first and second direction while still allowing a compact configuration. Preferably said plane is substantially parallel to the plane or surface of the object to the cleaned. Specifically, said plane is preferably substantially parallel to the end plate wherein the to be cleaned tubes of a heat exchanger end. A particularly compact and efficient driving system is obtained if the linear motor is arranged to move the holder in a radial direction with respect to the rotation axis of the rotation motor.

According to a further preferred embodiment, the rotation motor is provided on the connection body. The rotation motor hereby rotates the supporting arm with respect to the connection body, wherein the rotation motor preferably interconnects the connection body and the supporting arm, such that only a single supporting arm is required. It is hereby preferred if the connection body and the rotation motor are arranged such that in connected state on a heat exchanger, the rotation axis of the rotation motor is substantially parallel to the tubes to be cleaned, i.e. perpendicular to the end surface of the object to be cleaned.

In order to be able to efficiently decouple the system according to the invention from an object to be cleaned to move and couple the system to the next object to be cleaned, it is preferred if the rotation motor comprises a removable rotation axle for decoupling the supporting arm and the connection body upon removal of the rotation axle. The rotation axle and the housing of the rotation motor are hereby removable from each other, such that upon decoupling of the axle, the connection body and the supporting arm are also decoupled. The connection body and the supporting arm can then be transported separately. It is hereby preferred if the housing of the rotation motor is provided on the connection body, whereas the rotation axle of the rotation motor is associated, preferably coupled, with the supporting arm.

According to a further preferred embodiment, the linear motor comprises a rack and pinion or similar system. The supporting arm may for instance be provided with a rack, for instance a wall provided with a plurality of openings thereby forming a rack, wherein a pinion engages for moving the holder.

Although it is possible that the holder is moved along the supporting arm, i.e. along its longitudinal axis, it is preferred if, according to a further preferred embodiment, the holder is coupled to the supporting arm and wherein the linear motor is arranged to move the supporting arm with respect to the connection body. The combination of the supporting arm and the holder coupled thereto is thus moved with respect to the connection body. The linear motor can hereby be located close to the connection body, where also the rotation motor is preferably arranged as mentioned above. This results in a compact and robust configuration.

To however still be able to adjust the configuration of the holder and the supporting arm to the environment, it is preferred if the holder is removably coupled to the supporting arm for moving the holder along the longitudinal axis of the supporting arm. The holder is hereby preferably manually, thus not actively using a motor, movable along the supporting arm. The holder may for instance be provided with a clamp for clamping the supporting arm. It is further possible that the holder is provided with a connection system which cooperates with the rack-like structure on the supporting arm for mutually interconnecting the holder and the supporting arm. In case the wall of the supporting arm is provided with a plurality of openings along the length as mentioned above, the connection system may for instance comprise a pin which locks in at least one of said openings.

In case the linear motor is arranged to move the combination of the supporting arm and the holder with respect to the connection body a mentioned above, it is preferred if the system further comprises a sleeve for receiving the supporting arm, wherein the linear motor is arranged to move the supporting arm within the sleeve. The sleeve hereby closely receives and guides the supporting arm, such that the relative movement between the sleeve and supporting arm is substantially limited to a movement along one direction, preferably along the longitudinal axis of the supporting arm. The sleeve or tube hereto preferably has an inner cross sectional shape which corresponds to the cross sectional shape of the supporting arm. The cross section is preferably non-circular to prevent mutual rotation.

In case a removable rotation axle is used as mentioned above, it is preferred if the rotation axle is coupled to the sleeve. A robust configuration is hereby obtained which can be assembled and disassembled efficiently.

As the system according to the invention is particularly suitable to clean a heat exchanger in situ, i.e. without removing the heat exchanger from its surroundings, electric components are to be avoided. Therefore, according to a preferred embodiment, the motors comprise pneumatic motors. It is further preferred if the linear and rotation motors comprise the same type of pneumatic motors.

The motors are then coupled using suitable transmission means. Also the motor of the cleaning device is preferably of the same kind as the motors of the linear and rotation motor.

A further preferred embodiment of the system according to the invention further comprises a controller for remotely controlling at least the motors and preferably also a cleaning device held in the holder. The controller is then coupled to the motors and is provided with suitable control means for controlling the operation of the motor. Preferably the controller is coupled to the motors using pneumatic lines.

The present invention is further illustrated by the following Figures, which show a preferred embodiment of the system according to the invention, and are not intended to limit the scope of the invention in any way, wherein:

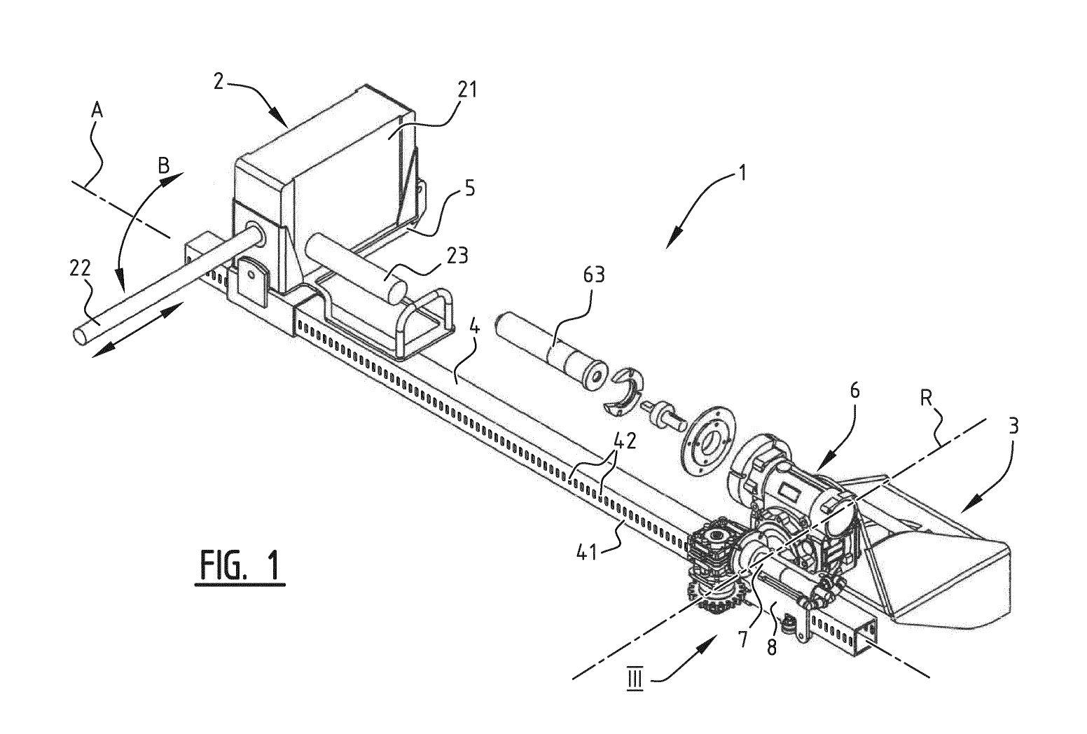

FIG. 1 shows the system in perspective view;

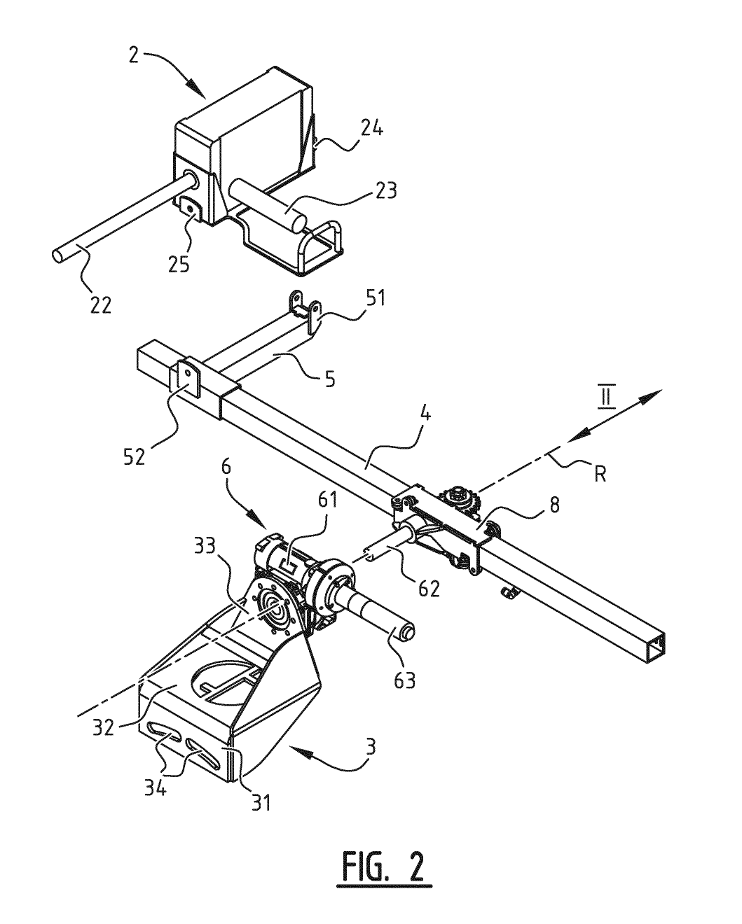

FIG. 2 shows the system in disassembled configuration;

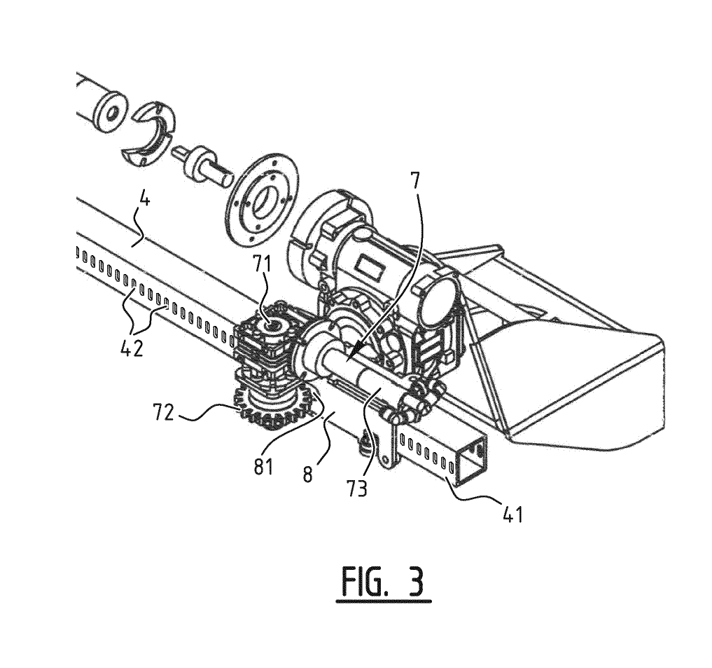

FIG. 3 is a detail of FIG. 1;

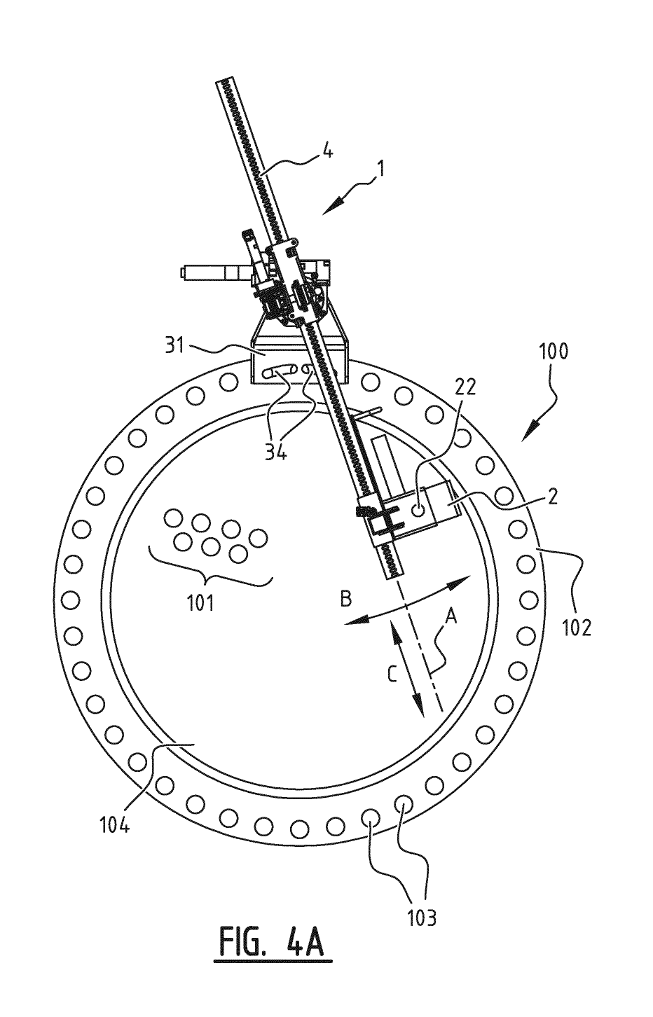

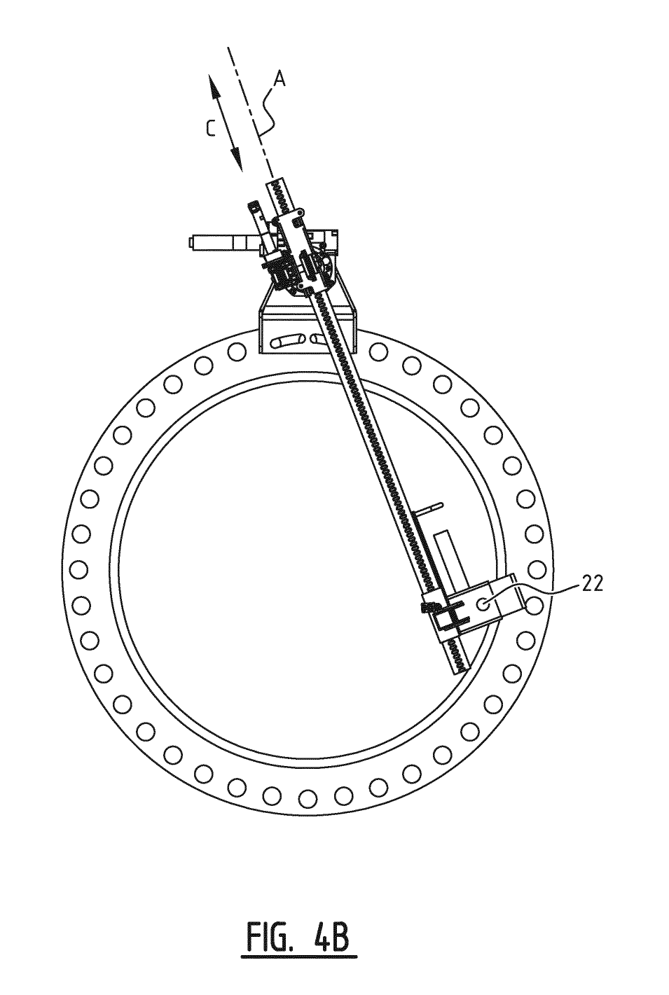

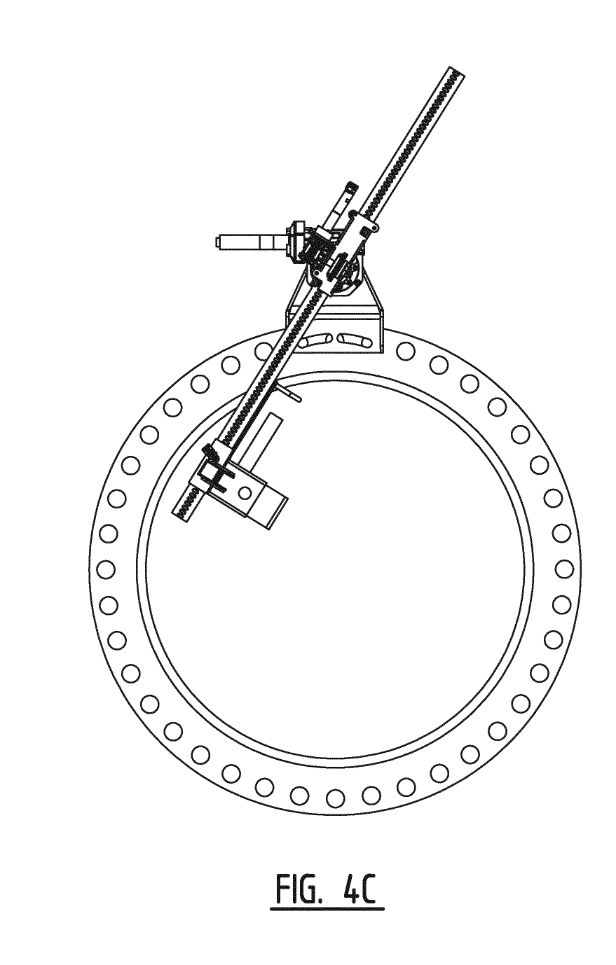

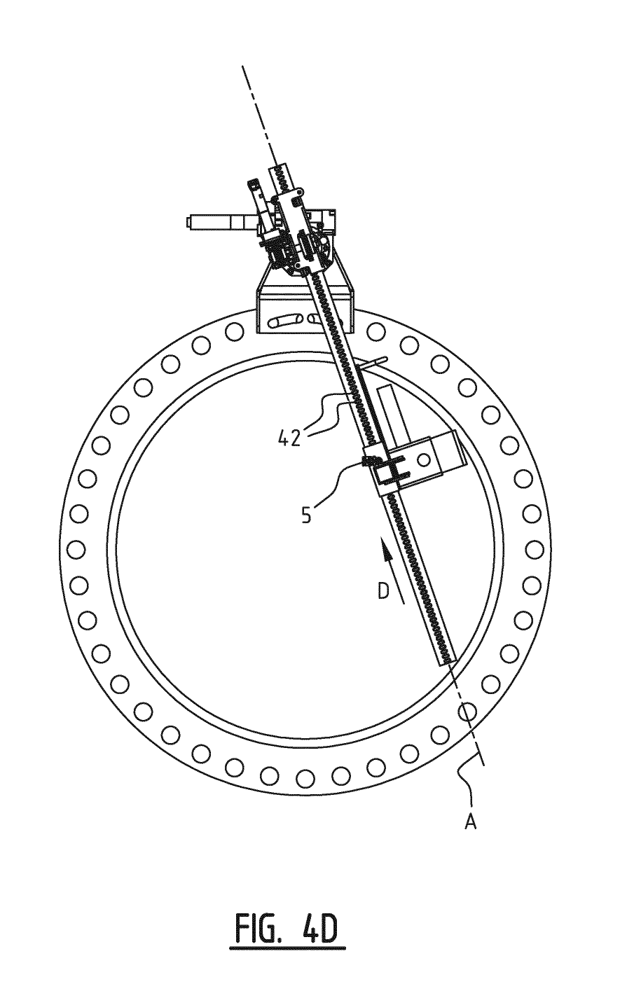

FIGS. 4a-d show the system on a heat exchanger in different positions.

In FIG. 1, a system 1 for cleaning a heat exchanger according to the invention is shown. The system 1 is provided with a connection body 3, a supporting arm 4 and a holder 5 onto which a cleaning device 2 is held. The supporting arm 4 is rotatable with respect to the connecting body 3 using a rotation motor 6. The supporting arm 4 with the holder 5 coupled thereto is further movable with respect the connection body 3 using a linear motor 7. The linear motor 7 is hereby arranged to move the cleaning device 2 in the longitudinal direction A of the supporting arm 4 and the rotation motor 6 is arranged to move the cleaning device 2 is a direction substantially perpendicular to this direction A by rotation along rotation axis R, schematically indicated with the double arrow B in FIG. 1.

Further referring to FIG. 2, it is noted that the orientation of the cleaning device 2 is different in the FIGS. 1 and 2 to indicate that with the system according to the invention, a versatile system is provided. It is noted that also different devices than the cleaning device 2 for feeding a cleaning lance can be connected to the holder 5.

Also the connection body 3 is in greater detail shown in FIG. 2. The connection body or connection device 3 is provided with a connection plate 31 wherein two slot shaped openings 34 are provided. The openings 34 are used to connect the connection body 3 to a flange of a heat exchanger by inserting bolts through the openings 34 and the respective openings in the flange. Via a connecting structure 32, the connection plate 31 is connected to a support plate 33 onto which the rotation motor 6 is supported. The connection device 3 is hereby arranged such that the rotation axis R of the rotation motor 6 extends perpendicular to the plane of the connection plate 31, such that the rotation axis R will be substantially parallel to the longitudinal axis of the heat exchanger to be cleaned. The rotation motor 6 comprises a motor housing 61 which is coupled to the support plate 33. A pneumatic motor 63 is coupled via suitable transmission means to the motor housing 61.

The rotation axle 62 of the rotation motor 6 can be decoupled from the motor housing 61 such that the axle can be moved in a direction of the rotation axis R, indicated with arrows II in FIG. 2. The axle 62 is interconnected with the supporting arm 4, in this example via sleeve 8 as will be explained in greater detail below, such that the supporting arm 4 and the connection device 3 can be decoupled by removing the rotation axle 62 from the rotation motor 6. Actuation of the rotation motor 6 rotates the supporting arm 4 with respect to connection body 3 along the rotation axis R.

Also with reference to FIG. 3, the linear motor 7 is in this embodiment in the form of a rack and pinion system, wherein a wall 41 of the supporting arm 4 is provided with a plurality of slots 42 along its length wherein a pinion 72 of the linear motor 7 engages for moving said arm 4. The linear motor 7 is connected and supported to a sleeve 8 which has a tube like body for receiving the supporting arm 4. The cross section of the arm 4 and the sleeve 8 thereby correspond such that any relative movement between the arm 4 and the sleeve 8 is limited along the longitudinal axis A of the arm 4. The sleeve 8 is provided with a slot 81 through which the pinion 72 extends such that the pinion 72 can engage the openings 42 in the wall 41 of the arm 4. The pinion 72 is connected to a pneumatic motor 73 via a suitable transmission 71. Actuation of the pneumatic motor 73 will thus rotate the pinion 72, thereby translating the arm 4 within sleeve 8 which is in this example rigidly coupled to the axle 62.

Provided near an outer end of the supporting arm 4 is a holder 5 which is arranged to couple to a cleaning device 2, see FIGS. 1 and 2. Cleaning device 2 is provided with a housing 21 wherein lance driving means are arranged which are arranged to move a high pressure lance in and out of an outlet opening 22 of the device 2. The driving means are operated by a pneumatic motor 23. In order to be able to replace the cleaning device 2 with another device, for instance another type of cleaning device, the holder is provided with locking means 51, 52 for removably interlocking the cleaning device 2 onto the holder 5. In this example, two space apart connection rings 51 are arranged to receive a ring 24 of the cleaning device 2 such that a pin can be received through rings 51 and 24. A connection plate 52 is further provided with an opening which is to coincide with an opening 25 of the cleaning device 2 to receive a connection pin there through.

The operation of the system 1 will now be explained while referring to FIGS. 4a-d. In these figures, the system 1 is seen to be coupled to a heat exchanger 100. The tube heat exchanger 100 as shown consists substantially of a bundle of tubes, only a few of which are indicated with 101, extending between two end plates of which one end plate 104 is visible. A flange 102 protrudes from the end of the heat exchanger 100 in which a plurality of openings 103 are provided. Two of the openings 103 are used to connect the connection plate 31 of the connection body 3 to the flange 102 by aligning the slots 34 with the two openings 103 of the flange 102 and by inserting bolts therein.

In the connected situation, the outlet 22 of the cleaning device 2 is arranged to be aligned such that a lance can be inserted substantially parallel into the tubes 101. The system 1 is hereby arranged to move the cleaning device 2 in a plane parallel to the end plate 104 such that the outlet 22 can be aligned with each of the tubes 101 for cleaning. Actuation of the linear motor 7 will hereby move the arm 4 with respect to the connection body 3, such that the cleaning device 2 is moved in a direction along the longitudinal direction A indicated with the arrows C. This movement can be seen when comparing FIGS. 4a and 4b. Actuation of the rotation motor 6 will move the cleaning device 2 in directions indicated with the arrows B in FIG. 4a. A clockwise movement of the cleaning device 2 can be seen when comparing FIGS. 4a and 4c. The combination of the linear motor 7 and the rotation motor 6 allows the cleaning device 2 to be moved over the whole surface 104 of the heat exchanger 100.

With reference to FIG. 4d, it can be seen that the holder 5 is manually movable along the arm 4, indicated with the arrow D. The holder 5 is in this example provided with slots which are to be aligned with openings 42 of the arm 4 such that by inserting a pins in the slots, the holder 5 is locked with respect to the arm 4. Movement of the holder 5 along the arm 4 is useful for situations where space is limited.

The present invention is not limited to the embodiment shown, but extends also to other embodiments falling within the scope of the appended claims.

1. System for cleaning an object, such as a heat exchanger comprising a bundle of feed-through tubes extending between two end plates, wherein the system comprises a connection body for connecting the system to an object, a holder for holding a cleaning device and a moving system for moving the holder with respect to the connection body in a first direction and a second direction at least having a component perpendicular to the first direction, wherein the moving system comprises a rotation motor and a linear motor.

2. System according to claim 1, wherein the connection body is arranged to be coupled to flange of a heat exchanger and is provided with a coupling plate with at least two slots for receiving bolts for coupling to the heat exchanger flange.

3. System according to claim 1 or 2, further comprising a cleaning device coupled to the holder, wherein the cleaning device is arranged for driving a flexible lance for cleaning a heat exchanger duct or the like, provided with a frame in which a means driving a flexible lance is arranged for moving this flexible lance in the direction of an outlet opening.

4. System according to claim 1, 2 or 3, further comprising a supporting arm for supporting the holder, wherein the rotation motor is arranged to rotate the supporting arm with respect to the connection body.

5. System according to claim 4, wherein the linear motor is arranged to move the holder in a plane perpendicular to the rotation axis of the rotation motor.

6. System according to claim 5, wherein the linear motor is arranged to move the holder in a radial direction with respect to the rotation axis of the rotation motor.

7. System according to claim 4, 5 or 6, wherein the rotation motor is provided on the connection body.

8. System according to claim 7, wherein the rotation motor comprises a removable rotation axle for decoupling the supporting arm and the connection body upon removal of the rotation axle.

9. System according to any of the preceding claims 4-8, wherein the linear motor comprises a rack and pinion system.

10. System according to any of the preceding claims 4-9, wherein the holder is coupled to the supporting arm and wherein the linear motor is arranged to move the supporting arm with respect to the connection body.

11. System according to claim 10, wherein the holder is removably coupled to the supporting arm for moving the holder along the longitudinal axis of the supporting arm.

12. System according to claim 10 or 11, comprising a sleeve for receiving the supporting arm, wherein the linear motor is arranged to move the supporting arm within the sleeve.

13. System according to claims 8 and 12, wherein the rotation axle is coupled to the sleeve.

14. System according to any of the preceding claims, wherein the motors comprise pneumatic motors.

15. System according to any of the preceding claims, further comprising a controller for remotely controlling at least the motors and preferably also a cleaning device held in the holder.
